(19) United States
(12) Patent Application Publication
(10) Pub. No.: US 2026/0101300 A1
(43) Pub. Date: Apr. 9, 2026

(54) TIME ALIGNMENT ENHANCEMENT FOR A SERVING CELL WITH MULTIPLE TIMING ADVANCE GROUPS (TAGS)

(71) Applicant: Telefonaktiebolaget LM Ericsson (publ), Stockholm (SE)

(72) Inventors: Shiwei GAO, Nepean (CA); Venkatarao GONUGUNTLA, Sundbyberg (SE); Siva MURUGANATHAN, Stittsville (CA); Claes TIDESTAV, Bålsta (SE)

(21) Appl. No.: 19/115,871

(22) PCT Filed: Sep. 29, 2023
(86) PCT No.: PCT/IB2023/059799

§ 371 Date: Mar. 27, 2025

Related U.S. Application Data
(60) Provisional application No. 63/412,296, filed on Sep. 30, 2022.

(51) Int. Cl. H04W 56/00; H04L 1/1812; H04W 24/10; H04W 72/21; H04W 74/0833

(52) U.S. Cl. CPC H04W 56/0045; H04L 1/1812; H04W 24/10; H04W 72/21; H04W 74/0833

(57) ABSTRACT

A method, network node and WD for time alignment enhancements for a serving cell with multiple timing advance groups (TAGs) are disclosed. According to one aspect, a method in a wireless device (WD) includes stopping first uplink transmissions associated with a first time alignment timer for a first TAG in a serving cell when the first time alignment timer expires. The method also includes continuing second uplink transmissions associated with a second time alignment timer for a second TAG in the same serving cell after the first time alignment timer has expired but before the second time alignment timer expires.

### FIELD

The present disclosure relates to wireless communications, and in particular, to time alignment enhancements for a serving cell with multiple timing advance groups (TAGs).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

NR uses CP-OFDM (Cyclic Prefix Orthogonal Frequency Division Multiplexing) in both downlink (DL) (i.e., from a network node, gNB, or base station, to a user equipment or WD) and uplink (UL) (i.e., from WD to gNB). Discrete Fourier transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically performed on a slot basis. An example is shown in FIG. 1 with a 14-symbol slot, where the first two symbols contain a physical downlink control channel (PDCCH) and the rest contains a physical shared data channel, either PDSCH (physical downlink shared channel) or a PUSCH (physical uplink shared channel).

Different subcarrier spacing (SCS) values are supported in NR. The supported SCS values (also referred to as different numerologies) are given by Δf=(15×2^{μ}) kHz where μ∈{0,1,2,3,4}. Δf=15 kHz is the basic subcarrier spacing. The slot duration for a given subcarrier spacing is

$$\frac{1}{{2}^{μ}} ms .$$

In the frequency domain, a system bandwidth is divided into resource blocks (RBs), each RB corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink transmissions to a WD may be dynamically scheduled by sending downlink control information (DCI) with a DL DCI format on PDCCH. The DCI contains scheduling information such as time and frequency resource, modulation and coding scheme, etc. The user data are carried on PDSCH. The WD first detects and decodes PDCCH and if the decoding is successfully, it then decodes the corresponding PDSCH according to the scheduling information in the DCI.

Similarly, uplink data transmission may be dynamically scheduled using a UL DCI format on PDCCH. A WD first decodes uplink grants in the DCI and then transmits data over PUSCH according to the control information contained in the uplink grant such as modulation order, coding rate, uplink resource allocation, etc.

In addition to dynamic scheduling, semi-persistent transmission of PUSCH using configured grants (CG) is also supported in NR. There are two types of CG-based PUSCH defined in NR 3GPP Technical Release 15 (3GPP Rel-15). In CG type 1, a periodicity of PUSCH transmission as well as the time domain offset are configured by radio resource control (RRC) signaling. In CG type 2, a periodicity of PUSCH transmission is configured by RRC and then the activation and release of such transmission is controlled by DCI, i.e., with a PDCCH.

### Time Alignment and Uplink Synchronization in NR

Different WDs in a cell may typically be located at different positions within the cell and then within different distances to the base station (e.g., NR gNodeB). As the WDs may be at different locations from the network node, if all WDs transmit to the network node at same time instance, transmissions from different WDs may reach the network node at different times. Unless all WD transmissions are received at the network node at the same time or within a certain reception window, they will interfere with each other. This results in demodulation difficulties at the network node. To ensure that the Uplink (UL) transmissions from a WD reaches the base station within the corresponding reception window in the base station, an uplink timing control procedure is used.

Time alignment of the uplink transmissions is achieved by applying a timing advance at the WD transmitter, relative to the received downlink timing. A purpose of applying the timing advance is to counteract different propagation delays between different WDs, as shown in FIG. 3 for an NR network node.

In order to achieve the time alignment between different WDs, the base station (e.g., gNodeB, eNodeB) derives the Timing Advance (TA) value to be used by the WD for the UL transmissions in order to reach the base station within the receive window. This TA is indicated to the WD.

FIG. 3 shows an example of UL time alignment without timing advance (a) and with timing advance (b).

### Acquiring Initial Timing Advance (TA)

A WD in NR typically acquires initial DL slot and symbol timing (DL timing in short) based on an SSBs (Synchronization Signals and Physical Broadcast Channel Blocks) and initial UL timing based on a random access procedure. In the random access procedure, the WD transmits a physical random access channel (PRACH) preamble (Msg1 for 4-step RACH or MsgA for 2-step RACH) in a PRACH resource associated with the SSB, The random access procedure uses the DL timing as a reference and a same transmission filter or beam as the one used in receiving the SSB.

Due to round trip propagation delay, the received PRACH preamble at the base station may not be aligned with the UL slot or symbol expected by the base station. A timing correction is then sent from the base station to the WD in a RACH response (RAR) message. The timing correction is referred to as a timing advance (TA), which is used to correct the WD UL transmission timing such that the subsequent UL channels or signals may reach the base station at the desired UL slot or symbol time. The TA is carried by a timing advance command (TAC) in the RAR. The RAR message format is shown in FIG. 4.

A timing advance command in RAR indicates timing advance N_{TA} values by index values of T_{A}=0, 1, 2, . . . , 3846, where an amount of the time alignment for a subcarrier spacing (SCS) of 2^{μ}·15 kHz is N_{TA}=T_{A}·16·64/2^{μ} T_{c}, where T_{c}=1/(Δfₘₐₓ·N_{f}), Δfₘₐₓ=480·10³ Hz, and N_{f}=4096.

In some scenarios, the UL and DL slot timing may be shifted intentionally by a configurable time offset, N_{TA,offset}. In that case, N_{TA} is applied in addition to the fixed timing advance offset N_{TA,offset}, i.e., the total applied timing advance is N_{TA,offset}+N_{TA}.

A RACH procedure may be initiated by either the network node or the WD. It may be contention based (CB) or contention free (CF). A RACH procedure may be initiated by the network node via a PDCCH order carried by a DCI with its cyclic redundance code (CRC) scrambled by the WD identity, i.e., C-RNTI (radio network temporary identifier). A PDCCH order contains information about a PRACH preamble index, a PRACH mask index, and an SSB index. The WD transmits PRACH according to the information. When the PRACH preamble index is non-zero, a contention free RACH (CFRA) procedure is triggered, in which the PRACH preamble is allocated only for the WD in a corresponding PRACH resource. Otherwise, a contention-based RACH (CBRA) procedure is triggered by the PDCCH order, in which the WD selects a PRACH preamble randomly from a set of PRACH preambles and the same preamble could be selected by more than one WDs in a same PRACH resource.

The WD may also initiate a RACH procedure by selecting a PRACH preamble index and a SSB and transmit a PRACH preamble in a PRACH resource associated to the selected SSB.

Each serving cell configuration may have a TAG identifier associated with, for example, a special cell (SpCell) and/or a secondary cell (SCell) of the cell group. Two serving cells having configured the same TAG identifier will be assumed by the WD to have the same time alignment timer and belong to the same Time Alignment Group.

### Uplink Time Alignment Maintenance

In carrier aggregation (CA), a WD may be configured with multiple serving cells. Some of the multiple serving cells may not be co-located and different TAs may be needed for UL transmissions to those cells. Cells that are co-located and may share a same TA value belong to a same timing advance group (TAG) and may be configured with a same TAG identifier or index (ID). For cells that are not co-located and need different TAs, they may be configured in different timing advance groups.

After the WD is configured with its serving cell(s) for a given cell group (e.g., Master Cell Group—MCG and/or Secondary Cell Group—SCG), the WD obtains the initial timing advance, TA, value via the random access response (RAR), and is configured with the association between serving cells and TAG identifiers. The WD may be configured to maintain the time alignment according to the TA procedure defined in Clause 5.2 in the 3GPP Technical Standard (TS) 38.321.

Except for the initial TA, which is carried in a RACH response message, regular TAs during time maintenance are carried in a timing advance command signaled using a medium access control (MAC) control element (CE) as shown in FIG. 5 (reproduced from 3GPP TS 38.321). The MAC CE may be configured to include:
TAG Identity (TAG ID): This field indicates the TAG Identity of the addressed TAG. The TAG containing the SpCell (i.e., a special cell which may be a primary cell in MCG or SCG, where a primary cell supports PUCCH transmission and contention-based Random Access, and is always activated) has the TAG Identity 0. The length of the field is 2 bits;
Timing Advance Command: This field indicates the index value T_{A} (0, 1, 2 . . . 63) used to control the amount of timing adjustment that MAC entity has to apply (as specified in 3GPP TS 38.213). The length of the field is 6 bits;
For a SCS of 2^{μ}·15 kHz, the timing advance command, T_{A}, for a TAG indicates the change of the uplink timing relative to the current uplink timing for the TAG in multiples of 16·64·T_{c}/2^{μ};
A timing advance command, T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 kHz, N_{TA_new}=N_{TA_old}+(T_{A}−31)·16·64/2^{μ} T_{c}; and
In addition, in some scenarios, the network node may send an absolute timing advance command via MAC CE to the WD as shown below, where “R” bit fields are reserved. In this case, timing advance N_{TA} values are indicated by index values of T_{A}=0, 1, 2, . . . , 3846, where an amount of the time alignment for a subcarrier spacing (SCS) of 2^{μ}·15 kHz is N_{TA}=T_{A}·16·64/2^{μ} T_{c}. See FIG. 6.

According to 3GPP TS 38.213, upon reception of a timing advance command for a TAG, the WD adjusts uplink timing for PUSCH/SRS/PUCCH transmissions on all the serving cells in the TAG based on a value N_{TA,offset} that the WD expects to be the same for all the serving cells in the TAG. The uplink timing adjustment is based on the received timing advance command where the uplink timing for PUSCH/SRS/PUCCH transmissions is the same for all the serving cells in the TAG.

For time alignment maintenance purposes, a time alignment timer per TAG is used to control how long the Medium Access Control (MAC) entity considers the Serving Cells belonging to the associated TAG to be uplink time aligned. The time Alignment Timer indicates a time duration within which the WD may consider a received TA value as valid. If the WD does not receive an updated value before the time Alignment Timer expires, the WD is no longer UL synchronized to the serving cells belonging to the corresponding TAG.

Upon reception of the Timing Advance Command (which is a MAC Control Element, or MAC CE), the WD applies the timing advance indicated in the command if the time alignment timer is still running and the timer is started or re-started.

When the time alignment timer expires, the following procedure is specified in 3GPP TS 38.321, where a PTAG (primary TAG) is a TAG containing the SpCell of a MAC entity and a STAG (secondary TAG) is a TAG containing cells other than a primary cell:
if the time Alignment Timer is associated with the PTAG:
flush all hybrid automatic repeat request (HARQ) buffers for all Serving Cells;
notify RRC to release PUCCH for all Serving Cells, if configured;
notify RRC to release sounding reference signaling (SRS) for all Serving Cells, if configured;
clear any configured downlink assignments and configured uplink grants;
clear any PUSCH resource for semi-persistent channel state information (CSI) reporting;
consider all running time Alignment Timers as expired;
maintain N_{TA} of all TAGs;
else if the time Alignment Timer is associated with an STAG, then for all Serving Cells belonging to this TAG:
flush all HARQ buffers;
notify RRC to release PUCCH, if configured;
notify RRC to release SRS, if configured;
clear any configured downlink assignments and configured uplink grants;
clear any PUSCH resource for semi-persistent CSI reporting; and
maintain N_{TA} of this TAG.

The MAC entity will not perform any uplink transmission on a Serving Cell except the Random Access Preamble when the time Alignment Timer associated with the TAG to which this Serving Cell belongs is not running. Furthermore, when the time Alignment Timer associated with the PTAG is not running, the MAC entity will not perform any uplink transmission on any Serving Cell except the Random Access Preamble on the SpCell. Further details of the maintenance procedure may be found in 3GPP TS 38.321.

### PDCCH Order

A PDCCH order is used by the network to initiate a RACH procedure and is carried by DCI format 1-0 when the DCI's CRC is scrambled by C-RNTI and the “Frequency domain resource assignment” field of the DCI contains all ones. The PDCCH order contains the following information:
Random Access Preamble index; and
SS/PBCH index. If the value of the “Random Access Preamble index” is not all zeros, this field indicates the SS/PBCH that will be used to determine the RACH occasion for the PRACH transmission; otherwise, this field is reserved; and
PRACH Mask index. If the value of the “Random Access Preamble index” is not all zeros, this field indicates the RACH occasion associated with the SS/PBCH indicated by “SS/PBCH index” for the PRACH transmission, according to Clause 5.1.1 of 3GPP TS 38.321; otherwise, this field is reserved

### Multi-DCI Scheduling

In NR 3GPP Release 16, multi-DCI based DL and UL scheduling was introduced, in which a WD may receive two DCI formats, a first and a second DCI formats, carried by two PDCCHs, a first and a second PDCCHs, in two control resource sets (CORESETs), a first and a second CORESET, respectively, in a slot. The first and second CORESETs are associated with a first and a second CORESET pool indices. The first and second DCI formats schedule a first and a second PDSCHs transmitted from a first and a second two transmission and reception points, TRPs, respectively. The two TRPs may belong to a same serving cell or different cells. It is assumed that the time difference between the two TRPs are very small and within the cyclic prefix (CP) so that a common DL and UL timing is used for both TRPs.

An example is shown in FIG. 7, where PDCCH 1 in CORESET 1 with CORESET pool index=0 scheduling PDSCH1 from TRP1 while PDCCH 2 in CORESET 2 with CORESET pool index=1 scheduling PDSCH2 from TRP2. The two PDSCHs may be fully, partially or non-overlapping in time. The HARQ acknowledgement (ACK) associated with PDSCH1 and PDSCH2 are carried in PUCCH1 and PUCCH2, respectively, which are non-overlapping in time and are transmitted towards TRP1 and TRP2, respectively.

Similarly, a PUSCH towards TRP1 may be scheduled by a DCI format carried in a PDCCH in CORESET 1 and a PUSCH towards TRP2 may be scheduled by a DCI format carried in a PDCCH in CORESET 2. An example is shown in FIG. 7, where PDCCH 3 in CORESET 1 with CORESET pool index=0 scheduling PUSCH1 from TRP1 while PDCCH 4 in CORESET 2 with CORESET pool index=1 scheduling PUSCH2 from TRP2. PUSCH1 and PUSH2 are non-overlapping in time. See FIG. 8.

For multi-DCI multi-TRP operation, a WD needs to be configured with two CORESET pools, each associated with a TRP. Each CORESET pool is a collection of CORESETs configured with a same CORESET pool index.

In case the TRPs belongs to a different cell with a different PCI (Physical Cell Identifier), the PCI is included in the TCI states associated to the TRP. In addition, SSBs associated to the PCI are configured to the WD.

In NR 3GPP Rel-18, two TAs, one for each TRP, are to be supported for multi-DCI based uplink transmissions towards two TRPs in a same serving cell, where a large time difference between the two TRPs may exist. For UL transmissions to different TRPs, different timing advances are applied such that the received UL signals at each intended TRP are time aligned.

For this purpose, it has been considered that a serving cell may be configured with two TAGs, one associated to each TRP. A separate timing alignment timer would be associated to each of the two TAGs.

One issue is how to acquire the initial TAs for the two TRPs. TRP specific PRACH triggered by PDCCH order has been proposed, in which each TRP may send a PDCCH order in an CORESET with an CORESET pool index associated to the TRP to trigger a PRACH transmission to the TRP.

Another issue is how to associate a TAC in a RAR or an absolute TAC to one of the two TAGs. One proposed solution is to have an implicit association between a TAC in RAR and a TAG. For example, if a RAR is in response to a PDCCH order scheduled by a DCI in a CORESET associated with TAG #k, then the TAC in the RAR is for TAG #k. Another proposed solution is to include a TAG ID in the PDCCH order and the corresponding RAR would be applicable to the TAG indicated in the PDCCH order.

Another proposed solution is to indicate explicitly in RAR which TA or TAG that the TAC contained in the RAR is applicable.

In case of inter-cell multi-DCI, in which a second TRP is associated with a different physical cell Identifier (PCI), it has been proposed to signal a RACH configuration including RACH preambles and resources associated to the PCI to the WD. The signaled RACH configuration may include a type-1 common search space (CSS) set configuration associated to the PCI, which is used to monitor PDCCH that scheduled RAR PDSCH.

According to an existing rule in NR, a PDCCH order transmitted in a SpCell and a PDCCH scheduling the corresponding RAR should be transmitted with the same spatial filter. This means that when the two TRPs belong to a SpCell, a PDCCH order and the corresponding RAR need to be sent from the same TRP. This is an issue for TRP specific PRACH as it would require configuring two type-1 CSS sets, one associated with each TRP. However, type-1 CSS is cell specific and cannot be configured in a per WD basis.

When one of the two time-alignment timers expires, how to re-acquire TA for the associated TAG is another unresolved issue.

### SUMMARY

Some embodiments advantageously provide methods, network nodes and wireless devices for time alignment enhancements for a serving cell with multiple timing advance groups (TAGs).

A method is proposed for acquiring initial TAs by a WD for two TAGs, a first and a second TAG, in a serving cell with two TRPs, a first and a second TRP, where the first and second TAGs are associated with the first and second TRPs. In some embodiments, a method may include one or more of the following:
Receiving a PDCCH order;
Transmitting a PRACH according to the PDCCH order;
Determining to monitor and receive one of:
   A RACH response associated to the PRACH; and/or
   A MAC CE containing a timing advance command addressed to the WD;
Receiving a timing advance (TA) and an associated TAG ID contained in the RACH response or the MAC CE;
Applying the TA to the uplink channels or signals associated to the TAG;
Re-acquiring TA when one of the two time alignment timers associated to the two TAGs expires:
   Notifying the timer expiration to the TRP for which the associated time alignment timer is still running; and/or
   Initiate a PRACH with dedicated preamble:
      Monitoring a MAC CE containing a timing advance command addressed to the WD.

Some embodiments may include one or more of the following:
Monitoring a timing advance command in a MAC CE addressed to the WD after a PRACH transmission initiated by a PDCCH order:
   Which is indicated either explicitly in the PDCCH order or implicitly when dedicated PRACH preambles for the purpose are configured and transmitted:
   A TAG ID is contained in the TAC;
Re-acquiring TA when one of two time alignment timers associated to the two TAGs expires:
   Notifying the timer expiration to the TRP for which the associated time alignment timer is still running and waiting for a PDCCH order from the TRP for which the timer has expired; and/or
   Initiate a PRACH with dedicated preamble:
      Monitoring a MAC CE containing a timing advance command addressed to the WD.

In some embodiments, a WD does not need to monitor a RACH response after a PRACH transmission for acquiring an initial TA associated to a TAG. This is more flexible and allows a time advance command with initial TA to be sent to a WD from a same TRP for which a PRACH is sent to. This eliminates the need for message exchange between the two TRPs, which may be slow. With explicit TAG ID indication in MAC CE, a PRACH may be triggered flexibly from any TRP.

According to one aspect, a network node configured to communicate with a wireless device, WD, is provided. The network node is configured to configure the WD to stop first uplink transmissions associated with a first time alignment timer for a first timing advance group, TAG, in a first serving cell when the first time alignment timer expires. The network node is configured to configure the WD to continue second uplink transmissions associated with a second time alignment timer for a second TAG in the first serving cell after the first time alignment timer has expired but before the second time alignment timer expires.

According to this aspect, in some embodiments, the first and the second TAGs are both primary TAGs, a primary TAG including a primary cell or a special cell. In some embodiments, the first and the second uplink transmissions include transmissions of one or more of a physical uplink shared channel, PUSCH, physical uplink control channel, PUCCH, and sounding reference signal, SRS. In some embodiments, the first and the second uplink transmissions are associated to the first and the second TAGs, respectively. In some embodiments, the network node is configured to configure the WD to: flush by the WD hybrid automatic repeat request, HARQ, buffers associated with the first TAG; clear any configured downlink assignments and configured uplink grants associated with the first TAG; clear any PUSCH resource for semi-persistent channel state information, CSI, reporting associated with the first TAG; and maintain timing advance values of both the first and second TAGs. In some embodiments, the second transmission comprises transmissions of one or more of a physical uplink control channel, PUCCH, and sounding reference signal, SRS. In some embodiments, the first and the second TAGs are both secondary TAGs, and wherein serving cells associated to a secondary TAG are secondary cells. In some embodiments, the network node is configured to, for serving cell(s), other than the first serving cell, associated with only the first TAG and not associated with a third TAG, configure the WD to: flush hybrid automatic repeat request, HARQ, buffers for the other serving cells belonging to the first TAG; release PUCCH, if configured; release SRS, if configured; clear any configured downlink assignments and configured uplink grants associated with the first TAG; clear any PUSCH resource for semi-persistent channel state information, CSI; reporting associated with the first TAG; and maintain timing advance values of the first TAG. In some embodiments, the network node is configured to, when at least one serving cell belonging to the first TAG is also associated with a third TAG for which an associated time alignment timer is still running, configure the WD to: flush hybrid automatic repeat request buffers associated to the first TAG for the at least one serving cell; clear any configured downlink assignments and configured uplink grants; associated with the first TAG; clear any PUSCH resource for semi-persistent channel state information, CSI; reporting associated with the first TAG; and maintain timing advance values of both the first and second TAGs. In some embodiments, the third TAG is one of a primary TAG and a secondary TAG. In some embodiments, continuing the second uplink transmissions includes transmitting at least one of an uplink control channel and a reference signal using a timing advance associated with the second primary TAG. In some embodiments, the network node is configured to retain configured downlink assignments and configured uplink grants associated with the second TAG when the first time alignment timer has expired and the second time alignment timer has not expired. In some embodiments, the first uplink transmissions exclude transmission of a random access preamble. In some embodiments, the network node is configured to, when the first and second time alignment timer have expired, prioritize transmission of a physical random access channel to one of the first and second TRPs. In some embodiments, the prioritization is based at least in part on an implementation of the WD.

According to another aspect, a method in a network node configured to communicate with a wireless device, WD, is provided. The method includes configuring the WD to stop first uplink transmissions associated with a first time alignment timer for a first timing advance group, TAG, in a first serving cell when the first time alignment timer expires. The method includes configuring the WD to continue second uplink transmissions associated with a second time alignment timer for a second TAG in the first serving cell after the first time alignment timer has expired but before the second time alignment timer expires.

In some embodiments, the first and the second TAGs are both primary TAGs, a primary TAG including a primary cell or a special cell. In some embodiments, the first and the second uplink transmissions include transmissions of one or more of a physical uplink shared channel, PUSCH, physical uplink control channel, PUCCH, and sounding reference signal, SRS. In some embodiments, wherein the first and the second uplink transmissions are associated to the first and the second TAGs, respectively. In some embodiments, the method includes configuring the WD to: flush hybrid automatic repeat request, HARQ, buffers associated with the first TAG; clear any configured downlink assignments and configured uplink grants associated with the first TAG; clear any PUSCH resource for semi-persistent channel state information, CSI, reporting associated with the first TAG; and maintain timing advance values of both the first and second TAGs. In some embodiments, the second transmission comprises transmissions of one or more of a physical uplink control channel, PUCCH, and sounding reference signal, SRS. In some embodiments, the first and the second TAGs are both secondary TAGs, and wherein serving cells associated to a secondary TAG are secondary cells. In some embodiments, the method includes, for serving cell(s), other than the first serving cell, associated with only the first TAG and not associated with a third TAG, configuring the WD to: flush hybrid automatic repeat request, HARQ, buffers for the other serving cells belonging to the first TAG; release PUCCH, if configured; release SRS, if configured; clear any configured downlink assignments and configured uplink grants associated with the first TAG; clear any PUSCH resource for semi-persistent channel state information, CSI; reporting associated with the first TAG; and maintain timing advance values of the first TAG. In some embodiments, the method includes, when at least one serving cell belonging to the first TAG is also associated with a third TAG for which an associated time alignment timer is still running, configuring the WD to: flush hybrid automatic repeat request buffers associated to the first TAG for the at least one serving cell; clear any configured downlink assignments and configured uplink grants; associated with the first TAG; clear any PUSCH resource for semi-persistent channel state information, CSI; reporting associated with the first TAG; and maintain timing advance values of both the first and second TAGs. In some embodiments, the third TAG is one of a primary TAG and a secondary TAG. In some embodiments, continuing the second uplink transmissions includes transmitting at least one of an uplink control channel and a reference signal using a timing advance associated with the second primary TAG. In some embodiments, the method includes retaining configured downlink assignments and configured uplink grants associated with the second TAG when the first time alignment timer has expired and the second time alignment timer has not expired. In some embodiments, the first uplink transmissions exclude transmission of a random access preamble. In some embodiments, the method includes, when the first and second time alignment timer have expired, prioritizing transmission of a physical random access channel to one of the first and second TRPs. In some embodiments, the prioritization is based at least in part on an implementation of the WD.

According to yet another aspect, a WD configured to communicate with a network node is provided. The WD is configured to: stop first uplink transmissions associated with a first time alignment timer for a first timing advance group, TAG, in a serving cell when the first time alignment timer expires; and continue second uplink transmissions associated with a second time alignment timer for a second TAG in the same serving cell after the first time alignment timer has expired but before the second time alignment timer expires.

According to this aspect, in some embodiments, the first and the second TAGs are both primary TAGs, a primary TAG including a primary cell or a special cell. In some embodiments, the first and the second uplink transmissions include transmissions of one or more of a physical uplink shared channel, PUSCH, physical uplink control channel, PUCCH, and sounding reference signal, SRS. In some embodiments, the first and the second uplink transmissions are associated to the first and the second TAGs, respectively. In some embodiments, the WD is configured to: flush hybrid automatic repeat request, HARQ, buffers associated with the first primary TAG; clear any configured downlink assignments and configured uplink grants associated with the first TAG; clear any PUSCH resource for semi-persistent channel state information, CSI, reporting associated with the first TAG; and maintain timing advance values of both the first and second TAGs. In some embodiments, the WD is configured to, when at least one serving cell belonging to the first TAG is also associated with a third TAG, for which an associated time alignment timer has not expired, configured the WD to: flush hybrid automatic repeat request buffers associated to the first TAG for the at least one serving cell; clear any configured downlink assignments and configured uplink grants; associated with the first TAG; clear any PUSCH resource for semi-persistent channel state information, CSI; reporting associated with the first TAG; and maintain timing advance values of both the first and second TAGs. In some embodiments, the third TAG is one of a primary TAG and a secondary TAG. In some embodiments, continuing the second uplink transmissions includes transmitting at least one of an uplink control channel and a reference signal using a timing advance associated with the second primary TAG. In some embodiments, the WD is configured to retain configured downlink assignments and configured uplink grants associated with the second primary TAG when the first time alignment timer has expired and the second time alignment timer has not expired. In some embodiments, the first select uplink transmissions exclude transmission of a random access preamble. In some embodiments, the WD is configure to, when the first and second time alignment timer have expired, prioritize transmission of a physical random access channel to one of the first and second TRPs. In some embodiments, the prioritization is based at least in part on a comparison of signal powers of the first and second TRPs.

According to another aspect, a method in a wireless device, WD, configured to communicate with a network node is provided. The method includes: stopping first uplink transmissions associated with a first time alignment timer for a first timing advance group, TAG, in a serving cell when the first time alignment timer expires; and continuing second uplink transmissions associated with a second time alignment timer for a second TAG in the same serving cell after the first time alignment timer has expired but before the second time alignment timer expires.

According to this aspect, in some embodiments, the first and the second TAGs are both primary TAGs, a primary TAG including a primary cell or a special cell. In some embodiments, the first and the second uplink transmissions include transmissions of one or more of a physical uplink shared channel, PUSCH, physical uplink control channel, PUCCH, and sounding reference signal, SRS. In some embodiments, the first and the second uplink transmissions are associated to the first and the second TAGs, respectively. In some embodiments, the method includes: flushing hybrid automatic repeat request, HARQ, buffers associated with the first primary TAG; clearing any configured downlink assignments and configured uplink grants associated with the first TAG; clearing any PUSCH resource for semi-persistent channel state information, CSI, reporting associated with the first TAG; and maintaining timing advance values of both the first and second TAGs. In some embodiments, the method includes, when at least one serving cell belonging to the first TAG is also associated with a third TAG, for which an associated time alignment timer has not expired: flushing hybrid automatic repeat request buffers associated to the first TAG for the at least one serving cell; clearing any configured downlink assignments and configured uplink grants; associated with the first TAG; clearing any PUSCH resource for semi-persistent channel state information, CSI reporting associated with the first TAG; and maintaining timing advance values of both the first and second TAGs. In some embodiments, the third TAG is one of a primary TAG and a secondary TAG. In some embodiments, continuing the second uplink transmissions includes transmitting at least one of an uplink control channel and a reference signal using a timing advance associated with the second primary TAG. In some embodiments, the method includes retaining configured downlink assignments and configured uplink grants associated with the second primary TAG when the first time alignment timer has expired and the second time alignment timer has not expired. In some embodiments, the first select uplink transmissions exclude transmission of a random access preamble. In some embodiments, the method includes, when the first and second time alignment timer have expired, prioritizing transmission of a physical random access channel to one of the first and second TRPs. In some embodiments, the prioritization is based at least in part on a comparison of signal powers of the first and second TRPs.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an NR time-domain structure;

FIG. 2 is an NR physical resource grid;

FIG. 3 is a timing alignment diagram;

FIG. 4 is an RAR message;

FIG. 5 is a TAC MAC CE;

FIG. 6 is an absolute TAC MAC CE;

FIG. 7 illustrates multi-DCI based PDSCH scheduling;

FIG. 8 illustrates another example of multi-DCI based PDSCH scheduling;

FIG. 9 is a schematic diagram of an example network architecture illustrating a communication system connected via an intermediate network to a host computer according to the principles in the present disclosure;

FIG. 10 is a block diagram of a host computer communicating via a network node with a wireless device over an at least partially wireless connection according to some embodiments of the present disclosure;

FIG. 11 is a flowchart illustrating example methods implemented in a communication system including a host computer, a network node and a wireless device for executing a client application at a wireless device according to some embodiments of the present disclosure;

FIG. 12 is a flowchart illustrating example methods implemented in a communication system including a host computer, a network node and a wireless device for receiving user data at a wireless device according to some embodiments of the present disclosure;

FIG. 13 is a flowchart illustrating example methods implemented in a communication system including a host computer, a network node and a wireless device for receiving user data from the wireless device at a host computer according to some embodiments of the present disclosure;

FIG. 14 is a flowchart illustrating example methods implemented in a communication system including a host computer, a network node and a wireless device for receiving user data at a host computer according to some embodiments of the present disclosure;

FIG. 15 is a flowchart of an example process in a network node for time alignment enhancements for a serving cell with multiple timing advance groups (TAGs);

FIG. 16 is a flowchart of an example process in a wireless device for time alignment enhancements for a serving cell with multiple timing advance groups (TAGs);

FIG. 17 is a flowchart of another example process in a network node for time alignment enhancements for a serving cell with multiple timing advance groups (TAGs);

FIG. 18 is a flowchart of another example process in a wireless device for time alignment enhancements for a serving cell with multiple timing advance groups (TAGs);

FIG. 19 illustrates an example of time alignment with two different TAs;

FIG. 20 illustrates an example of triggering PRACH to any of two TRPs'

FIG. 21 illustrates a TAC;

FIG. 22 illustrates WD indication of expired time alignment timer; and

FIG. 23 is an example flow diagram for time alignment enhancements for a serving cell with multiple timing advance groups (TAGs).

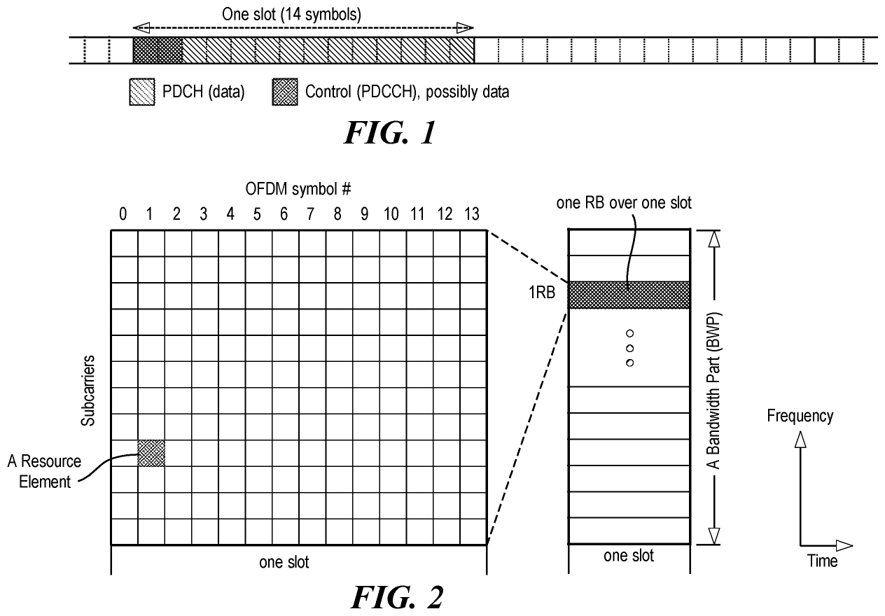

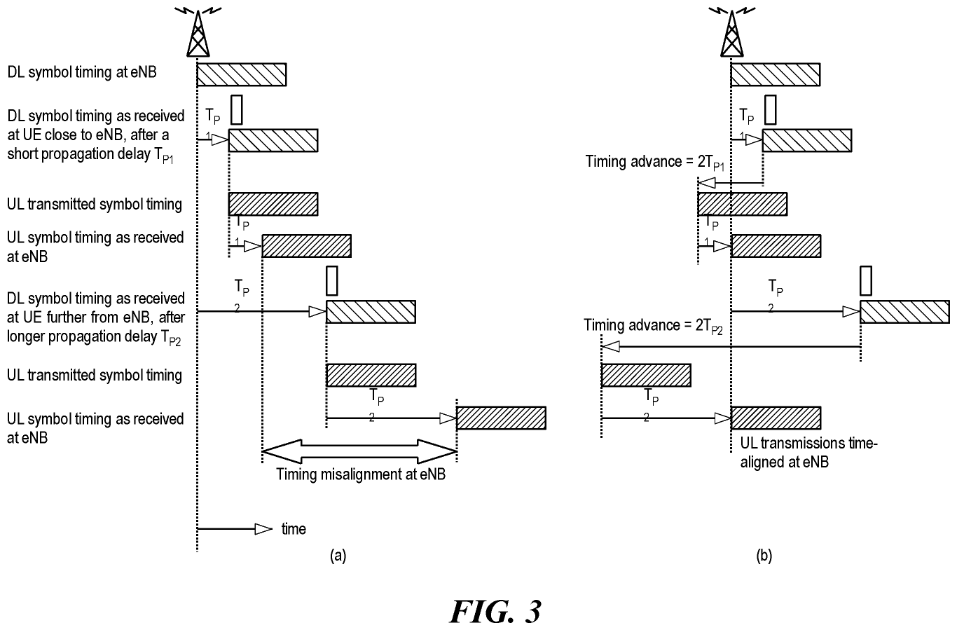

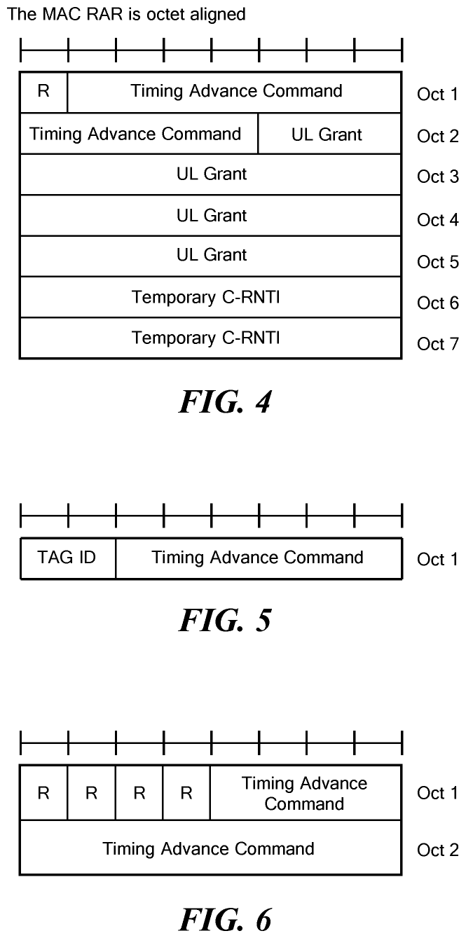

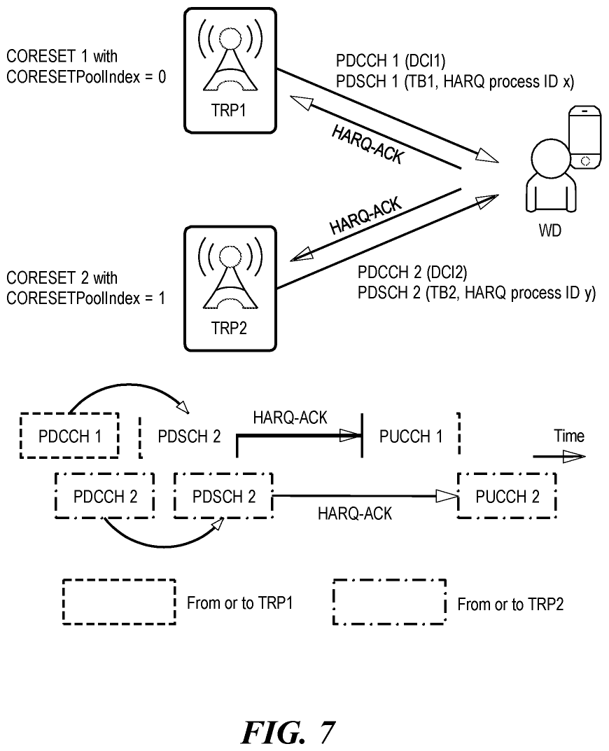

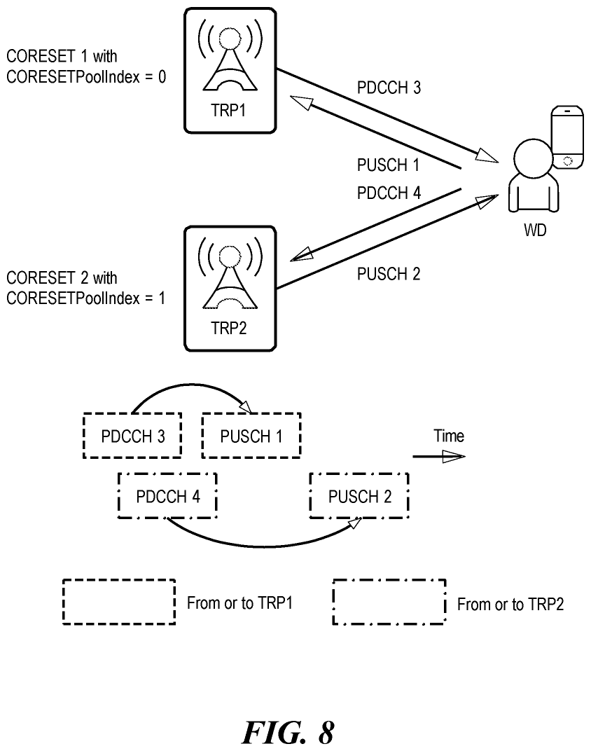

### DETAILED DESCRIPTION

Before describing in detail example embodiments, it is noted that the embodiments reside primarily in combinations of apparatus components and processing steps related to time alignment enhancements for a serving cell with multiple timing advance groups (TAGs). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “transmission and reception point” or “TRP” may refer to a network node. The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide time alignment enhancements for a serving cell with multiple timing advance groups (TAGs).

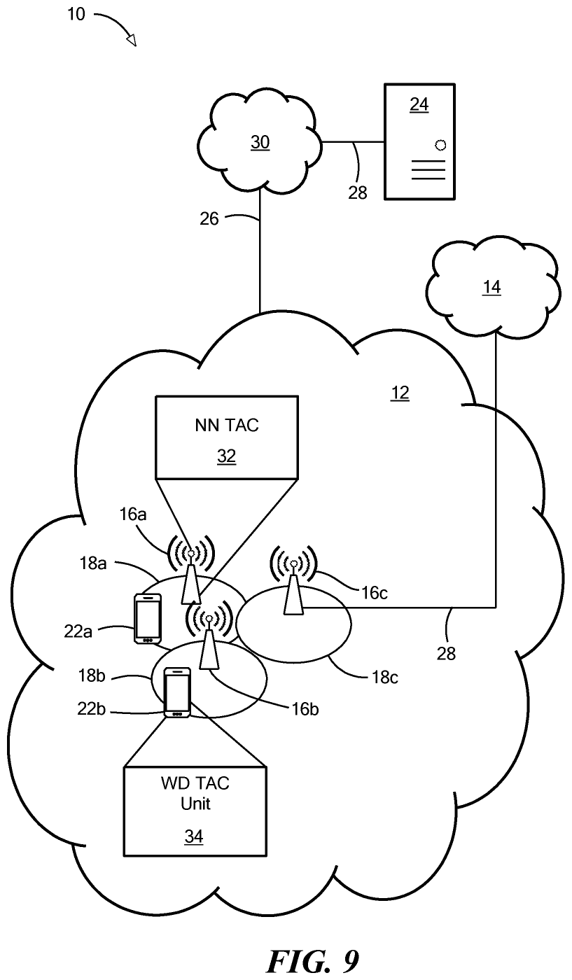

Referring again to the drawing figures, in which like elements are referred to by like reference numerals, there is shown in FIG. 9 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 9 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a network node (NN) TAC unit 32 which is configured to transmit to the WD a timing advance command, TAC, in one of a medium access control, MAC, control element, CE, and a random access response, RAR. The NN TAC unit 32 may be configured to configure the WD to stop first uplink transmissions associated with a first time alignment timer for a first timing advance group, TAG, in a first serving cell when the first time alignment timer expires. A wireless device 22 is configured to include a WD TAC unit 34 which is configured to monitor for, and receive, from the network node a timing advance command, TAC, and an associated timing advance group, TAG, ID on one of a medium access control, MAC, control element, CE, and a random access response, RAR. The WD TAC unit 34 may be configured to stop first uplink transmissions associated with a first time alignment timer for a first timing advance group, TAG, in a serving cell when the first time alignment timer expires.

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a network node (NN) TAC unit 32 which is configured to transmit to the WD a timing advance command, TAC, in one of a medium access control, MAC, control element, CE, and a random access response, RAR. The NN TAC unit 32 may be configured to configure the WD to stop first uplink transmissions associated with a first time alignment timer for a first timing advance group, TAG, in a first serving cell when the first time alignment timer expires.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD TAC unit 34 which is configured to monitor for, and receive, from the network node a timing advance command, TAC, and an associated timing advance group, TAG, ID on one of a medium access control, MAC, control element, CE, and a random access response, RAR. The WD TAC unit 34 may be configured to stop first uplink transmissions associated with a first time alignment timer for a first timing advance group, TAG, in a serving cell when the first time alignment timer expires.

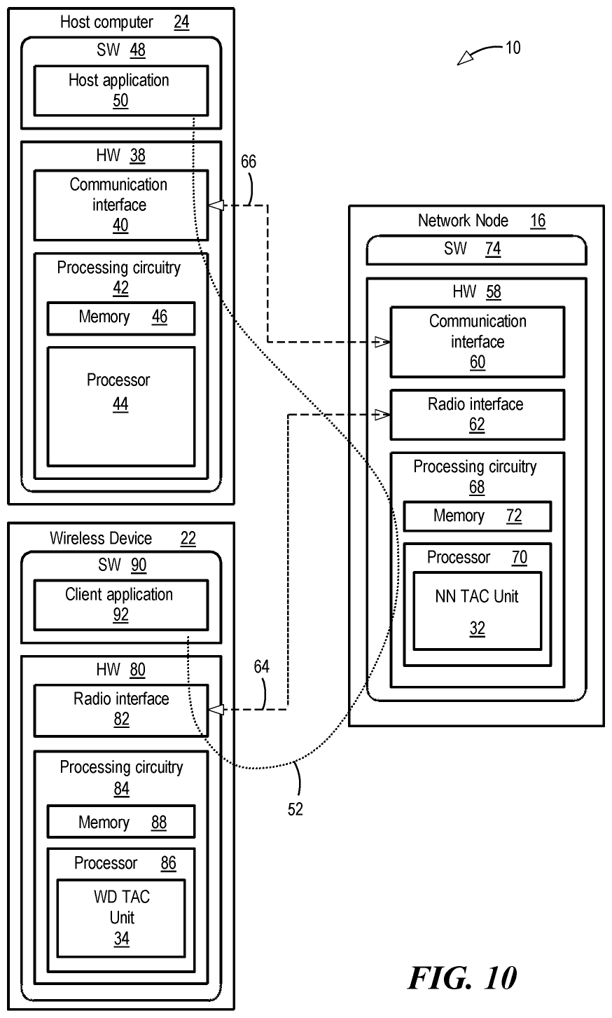

In some embodiments, the inner workings of the network node 16, WD 22, and host computer 24 may be as shown in FIG. 10 and independently, the surrounding network topology may be that of FIG. 9.

In FIG. 10, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 9 and 10 show various “units” such as NN TAC unit 32, and WD TAC unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

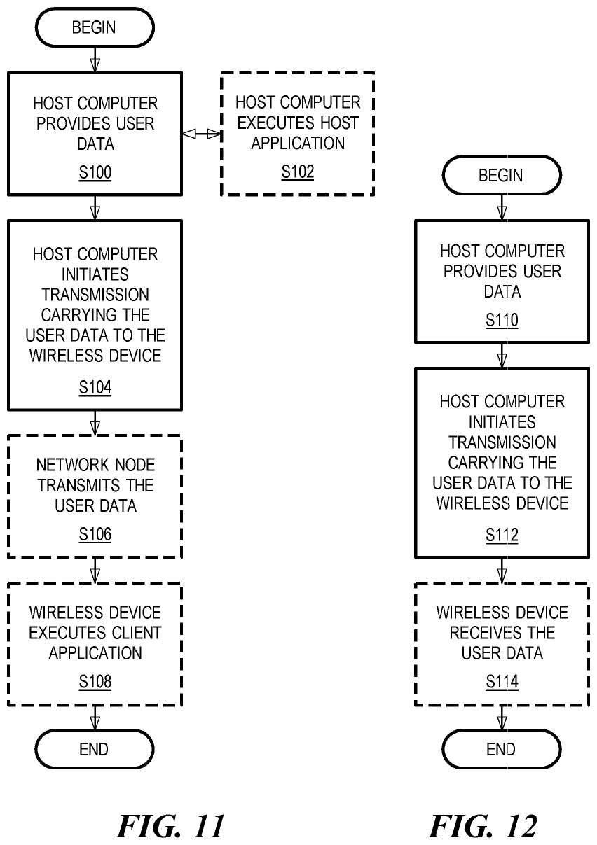

FIG. 11 is a flowchart illustrating an example method implemented in a communication system, such as, for example, the communication system of FIGS. 9 and 10, in accordance with one embodiment. The communication system may include a host computer 24, a network node 16 and a WD 22, which may be those described with reference to FIG. 10. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 12 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

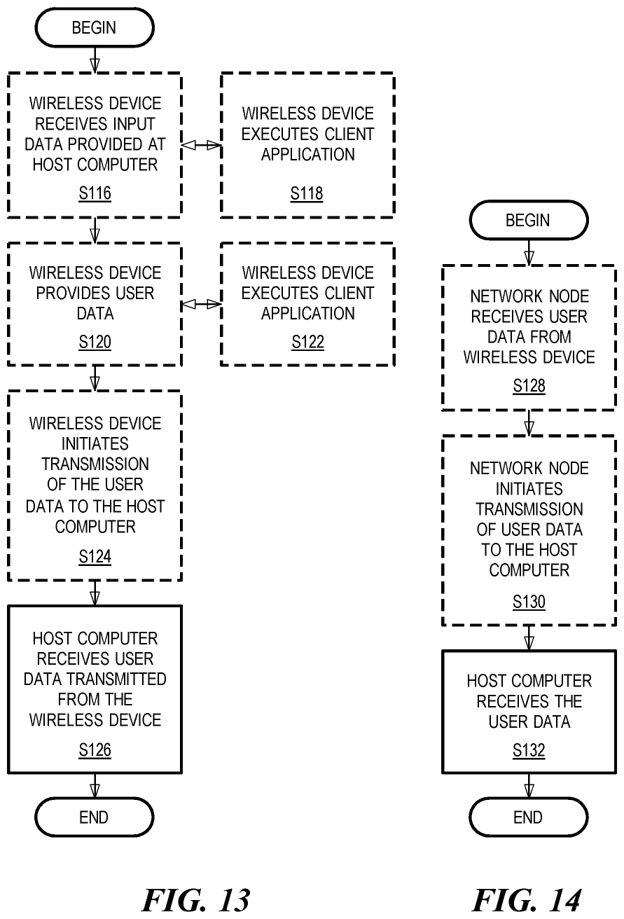

FIG. 13 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 14 is a flowchart illustrating an example method implemented in a communication system, such as, for example, the communication system of FIG. 9, in accordance with one embodiment. The communication system may include a host computer 24, a network node 16 and a WD 22, which may be those described with reference to FIGS. 9 and 10. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

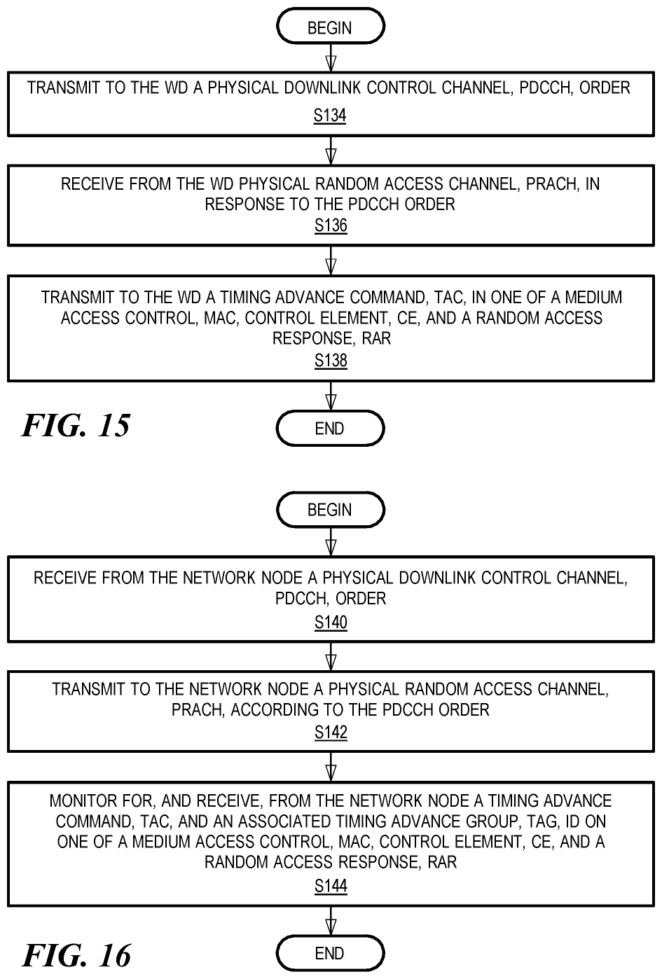

FIG. 15 is a flowchart of an example process in a network node 16 for time alignment enhancements for a serving cell with multiple timing advance groups (TAGs). One or more blocks described herein may be performed by one or more elements of network node 16 such as by one or more of processing circuitry 68 (including the NN TAC unit 32), processor 70, radio interface 62 and/or communication interface 60. Network node 16 such as via processing circuitry 68 and/or processor 70 and/or radio interface 62 and/or communication interface 60 is configured to transmitting to the WD a physical downlink control channel, PDCCH, order (Block S134). The process also includes receiving from the WD physical random access channel, PRACH, in response to the PDCCH order (Block S136). The process also includes transmitting to the WD a timing advance command, TAC, in one of a medium access control, MAC, control element, CE, and a random access response, RAR (Block S138).

In some embodiments, the TAC is associated with one of two timing advance groups, TAG. In some embodiments, each TAG is associated with an alignment timer.

FIG. 16 is a flowchart of an example process in a wireless device 22 according to some embodiments of the present disclosure. One or more blocks described herein may be performed by one or more elements of wireless device 22 such as by one or more of processing circuitry 84 (including the WD TAC unit 34), processor 86, radio interface 82 and/or communication interface 60. Wireless device 22 such as via processing circuitry 84 and/or processor 86 and/or radio interface 82 is configured to receive from the network node a physical downlink control channel, PDCCH, order (Block S140). The process also includes transmitting to the network node a physical random access channel, PRACH, according to the PDCCH order (Block S142). The process also includes monitoring for, and receiving, from the network node a timing advance command, TAC, and an associated timing advance group, TAG, ID on one of a medium access control, MAC, control element, CE, and a random access response, RAR (Block S144).

In some embodiments, the method also includes applying a timing advance, TA, indicated by the TAC. In some embodiments, the method also includes reacquiring a timing advance, TA, when of two alignment timers associated with two timing advance groups, TAGs, expires. In some embodiments, the method also includes notifying the network node of the expiration of the one of two alignment timers. In some embodiments, the method also includes initiating a PRACH with dedicated preamble and monitor for another TAC.

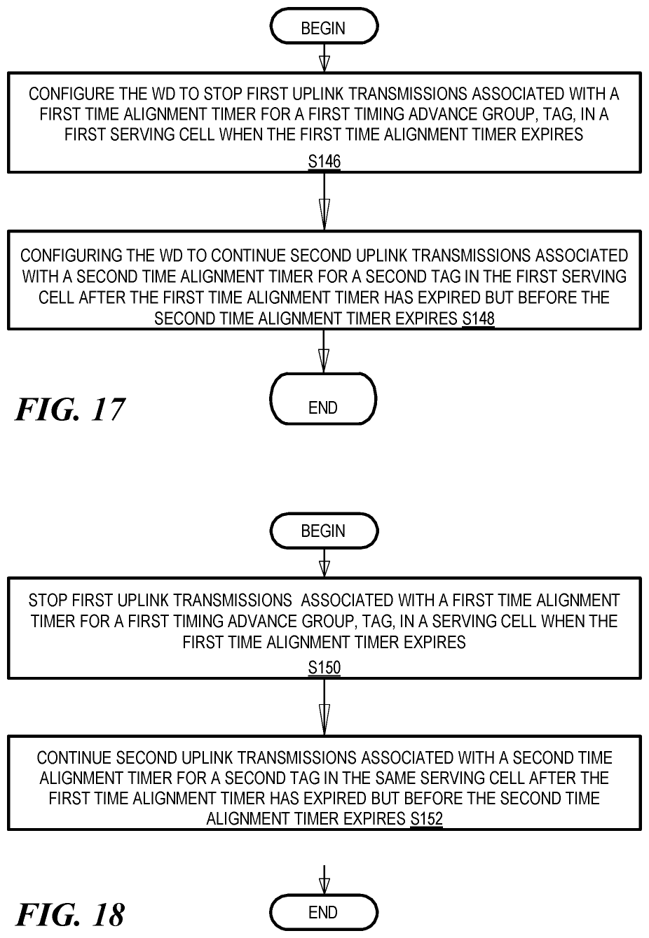

FIG. 17 is a flowchart of an example process in a network node 16 for time alignment enhancements for a serving cell with multiple timing advance groups (TAGs). One or more blocks described herein may be performed by one or more elements of network node 16 such as by one or more of processing circuitry 68 (including the NN TAC unit 32), processor 70, radio interface 62 and/or communication interface 60. Network node 16 such as via processing circuitry 68 and/or processor 70 and/or radio interface 62 and/or communication interface 60 is configured to: configure the WD 22 to stop first uplink transmissions associated with a first time alignment timer for a first timing advance group, TAG, in a first serving cell when the first time alignment timer expires (Block S146). The method includes configuring the WD 22 to continue second uplink transmissions associated with a second time alignment timer for a second TAG in the first serving cell after the first time alignment timer has expired but before the second time alignment timer expires (Block S148).

In some embodiments, the first and the second TAGs are both primary TAGs, a primary TAG including a primary cell or a special cell. In some embodiments, the first and the second uplink transmissions include transmissions of one or more of a physical uplink shared channel, PUSCH, physical uplink control channel, PUCCH, and sounding reference signal, SRS. In some embodiments, wherein the first and the second uplink transmissions are associated to the first and the second TAGs, respectively. In some embodiments, the method includes configuring the WD 22 to: flush hybrid automatic repeat request, HARQ, buffers associated with the first TAG; clear any configured downlink assignments and configured uplink grants associated with the first TAG; clear any PUSCH resource for semi-persistent channel state information, CSI, reporting associated with the first TAG; and maintain timing advance values of both the first and second TAGs. In some embodiments, the second transmission comprises transmissions of one or more of a physical uplink control channel, PUCCH, and sounding reference signal, SRS. In some embodiments, the first and the second TAGs are both secondary TAGs, and wherein serving cells associated to a secondary TAG are secondary cells. In some embodiments, the method includes, for serving cell(s), other than the first serving cell, associated with only the first TAG and not associated with a third TAG, configuring the WD 22 to: flush hybrid automatic repeat request, HARQ, buffers for the other serving cells belonging to the first TAG; release PUCCH, if configured; release SRS, if configured; clear any configured downlink assignments and configured uplink grants associated with the first TAG; clear any PUSCH resource for semi-persistent channel state information, CSI; reporting associated with the first TAG; and maintain timing advance values of the first TAG. In some embodiments, the method includes, when at least one serving cell belonging to the first TAG is also associated with a third TAG for which an associated time alignment timer is still running, configuring the WD 22 to: flush hybrid automatic repeat request buffers associated to the first TAG for the at least one serving cell; clear any configured downlink assignments and configured uplink grants; associated with the first TAG; clear any PUSCH resource for semi-persistent channel state information, CSI; reporting associated with the first TAG; and maintain timing advance values of both the first and second TAGs. In some embodiments, the third TAG is one of a primary TAG and a secondary TAG. In some embodiments, continuing the second uplink transmissions includes transmitting at least one of an uplink control channel and a reference signal using a timing advance associated with the second primary TAG. In some embodiments, the method includes retaining configured downlink assignments and configured uplink grants associated with the second TAG when the first time alignment timer has expired and the second time alignment timer has not expired. In some embodiments, the first uplink transmissions exclude transmission of a random access preamble. In some embodiments, the method includes, when the first and second time alignment timer have expired, prioritizing transmission of a physical random access channel to one of the first and second TRPs. In some embodiments, the prioritization is based at least in part on an implementation of the WD 22.

FIG. 18 is a flowchart of an example process in a wireless device 22 according to some embodiments of the present disclosure. One or more blocks described herein may be performed by one or more elements of wireless device 22 such as by one or more of processing circuitry 84 (including the WD TAC unit 34), processor 86, radio interface 82 and/or communication interface 60. Wireless device 22 such as via processing circuitry 84 and/or processor 86 and/or radio interface 82 is configured to stop first uplink transmissions associated with a first time alignment timer for a first timing advance group, TAG, in a serving cell when the first time alignment timer expires (Block S150). The process includes continuing second uplink transmissions associated with a second time alignment timer for a second TAG in the same serving cell after the first time alignment timer has expired but before the second time alignment timer expires (Block S152).

According to this aspect, in some embodiments, the first and the second TAGs are both primary TAGs, a primary TAG including a primary cell or a special cell. In some embodiments, the first and the second uplink transmissions include transmissions of one or more of a physical uplink shared channel, PUSCH, physical uplink control channel, PUCCH, and sounding reference signal, SRS. In some embodiments, the first and the second uplink transmissions are associated to the first and the second TAGs, respectively. In some embodiments, the method includes: flushing hybrid automatic repeat request, HARQ, buffers associated with the first primary TAG; clearing any configured downlink assignments and configured uplink grants associated with the first TAG; clearing any PUSCH resource for semi-persistent channel state information, CSI, reporting associated with the first TAG; and maintaining timing advance values of both the first and second TAGs. In some embodiments, the method includes, when at least one serving cell belonging to the first TAG is also associated with a third TAG, for which an associated time alignment timer has not expired: flushing hybrid automatic repeat request buffers associated to the first TAG for the at least one serving cell; clearing any configured downlink assignments and configured uplink grants; associated with the first TAG; clearing any PUSCH resource for semi-persistent channel state information, CSI reporting associated with the first TAG; and maintaining timing advance values of both the first and second TAGs. In some embodiments, the third TAG is one of a primary TAG and a secondary TAG. In some embodiments, continuing the second uplink transmissions includes transmitting at least one of an uplink control channel and a reference signal using a timing advance associated with the second primary TAG. In some embodiments, the method includes retaining configured downlink assignments and configured uplink grants associated with the second primary TAG when the first time alignment timer has expired and the second time alignment timer has not expired. In some embodiments, the first select uplink transmissions exclude transmission of a random access preamble. In some embodiments, the method includes, when the first and second time alignment timer have expired, prioritizing transmission of a physical random access channel to one of the first and second TRPs. In some embodiments, the prioritization is based at least in part on a comparison of signal powers of the first and second TRPs.

Having described the general process flow of arrangements of the disclosure and having provided examples of hardware and software arrangements for implementing the processes and functions of the disclosure, the sections below provide details and examples of arrangements for time alignment enhancements for a serving cell with multiple timing advance groups (TAGs).

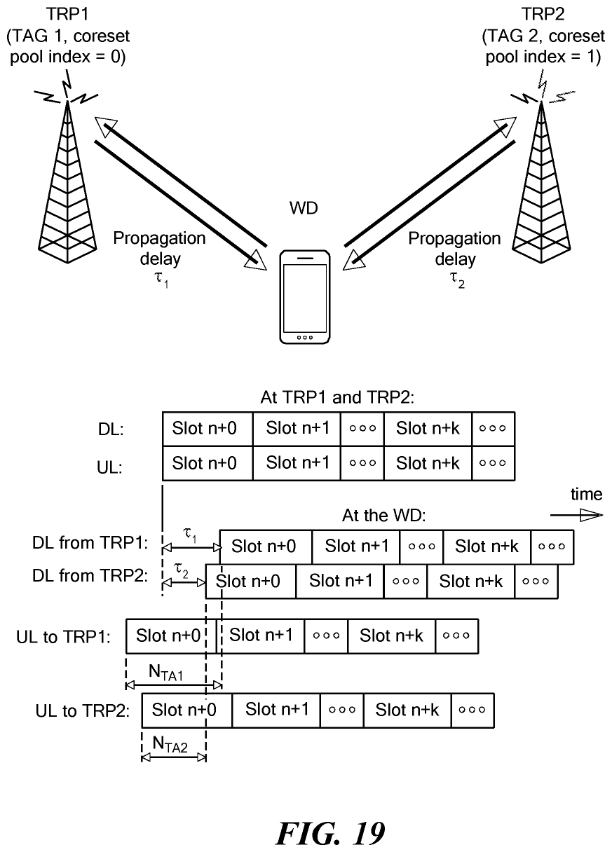

FIG. 19 shows an example of UL time alignment to two TRPs 16 with two timing advances, N_{TA1} and N_{TA2}. N_{TA1} and N_{TA2} are associated to two TAGs, a first TAG and a second TAG, respectively. Each of the two TAGs is associated with a respective time alignment timer.

In FIG. 19, it is assumed that the DL and UL slot/symbol timings are aligned at the two TRPs 16, I.e., N_{TA,offset}=0 for both TRPs 16. Due to different propagation delays from the two TRPs 16 to a WD 22, the received DL slot/symbol timings from the two TRPs 16 at the WD 22 are shifted in time. To achieve UL time alignment at each TRP 16, the WD 22 may be configured to apply two different timing advances to UL transmissions towards the two TRPs 16.

In FIG. 19, each of the two timing advances is with respect to the received DL timing from the respective TRP 16. Alternatively, both of the two timing advances may be with respect to a common DL timing at the WD 22, e.g., either based on a received DL slot/symbol timing from TRP1 or TRP2.

Note that the “TRP” may be paraphrased as, for example, a network node 16, a base station, an antenna apparatus, an antenna panel, a serving cell, a cell, a Component Carrier (CC), a carrier, and so on. The term “TRP”, “TAG”, and “CORESET pool index” are associated to each other and in the following, they may be used, interchangeably.

### Acquiring Initial TAs

### Embodiment 1: Triggering PRACH Transmissions Across TRPs 16

In case the serving cell for the two TRPs 16 is a SpCell, PDCCH order and the corresponding RAR are to be sent from a same TRP 16 according to existing rules in NR. Since there is only one type-1 CSS that may be configured for monitoring RAR by the WD 22, the RAR may only be sent from one of the two TRPs 16. Therefore, the network node 16 cannot send a PDCCH order from either of the two TRPs 16 to trigger a PRACH transmission to the respective TRP 16.

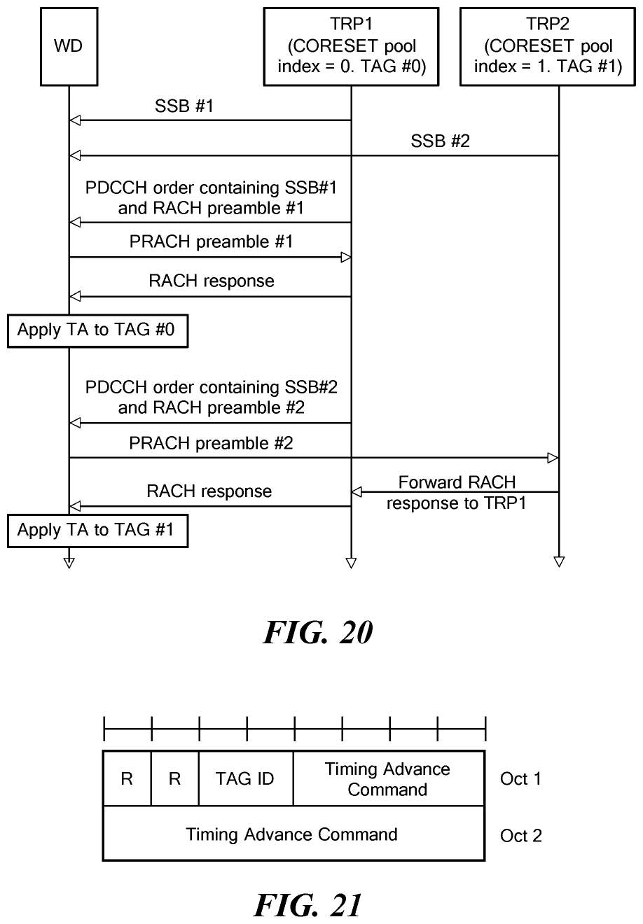

In some embodiments, a PDCCH order and a RACH response are sent from one of the two TRPs 16, e.g., TRP1. A PDCCH order may trigger a CFRA based PRACH transmission to either one of the two TRPs 16. The RAR PDSCH and the scheduling DCI format 1-0 for the RAR PDSCH may be sent from the same TRP 16 as the PDCCH order. The PDCCH order may include information of at least a PRACH preamble index, a SSB index, and a PRACH mask index for the WD 22 to determine an associated PRACH resource and a spatial filter to transmit a PRACH preamble specified by the PRACH preamble index. The SSB index is used to implicitly tell the WD 22 to which TRP 16 the PRACH preamble to be transmitted. When the RAR is received, the WD 22 applies a timing advance contained in the RAR to an associated TAG. The associated TAG may be indicated explicitly either in the PDCCH order, in the RAR, or implicitly by associating a TAG to a group of SSBs or PRACH preambles. An example is illustrated in FIG. 20.

In the above embodiment, in case of large signaling latency between the two TRPs 16, forwarding the RACH response between TRPs 16 may not be feasible as the WD 22 expects to receive the RAR within a certain time window.

In some embodiments, dedicated PRACH preamble(s) may be configured for time alignment purpose when two TAGs are configured in a serving cell. When a dedicated PRACH preamble is transmitted by the WD 22 to a TRP 16 associated with a TAG, the WD 22 may not expect to receive a RACH response and thus, may not monitor DCI 1-0 with CRC scrambled by RA-RNTI in a type1 CSS set. Instead, the WD 22 may monitor DCI with CRC scrambled by the WD's C-RNTI within a time window after the transmission of a dedicated PRACH preamble. The monitoring may be done in a dedicated search space set or in regular CORESETs associated to the TRP 16.

After the WD 22 detects a DCI format with CRC scrambled by C-RNTI in the search space set or in the CORESETs, the WD 22 may continue to monitor PDCCH candidates in the search space set or the CORESETs until the WD 22 receives a PDSCH carrying a MAC CE containing a timing advance command associated to the TAG. In this case, the timing advance command MAC CE may be sent to the WD 22 from the same TRP 16 to which the dedicated PRACH preamble is sent. The WD 22 may then apply the TA in the TAC to the associated TAG.

If a MAC CE containing a TAC is not received within the time window, the WD 22 may adjust the PRACH transmit power and send the PRACH again.

### Embodiment 2: Triggering of Node-Specific RACH Procedure

A PDCCH order is sent from either TRP 16;
The PDCCH order includes a pointer to a previously received RACH configuration. This configuration may include one or more of the following RACH related parameters:
Root Sequence Index: PRACH root sequence index for TA establishment in L1/L2 inter-cell mobility, to be possibly defined in 3GPP TS 38.211. This may be a field e.g., rootSequenceIndex of information element (IE) INTEGER (0 . . . 137));
Reference Signal Received Power (RSRP) threshold for SSB: L1-RSRP threshold used for determining whether a candidate beam may be used by the WD 22 to attempt contention free random access to establish TA with a target candidate cell. This may be a field rsrp-ThresholdSSB;
SSB(s) per RACH occasion(s): Number of SSBs per RACH occasion for contention free TA establishment with a target candidate cell. This may be the field ssb-perRACH-Occasion of IE ENUMERATED {oneEighth, oneFourth, oneHalf, one, two, four, eight, sixteen};
RA SSB occasion mask index: Explicitly signaled PRACH Mask Index for RA Resource selection, valid for one or more SSB resources. This may be the field ra-ssb-OccasionMaskIndex;
Subcarrier spacing for MSG1: Subcarrier spacing for contention free TA establishment with the target candidate cell e.g., values 15 kHz or 30 kHz (FR1), and 60 kHz or 120 kHz (FR2). This may be the parameter msgl-SubcarrierSpacing of IE SubcarrierSpacing;
The PDCCH order may explicitly indicate one or more of:
A PRACH preamble index;
A PRACH mask index;
A SSB index;
A PCI; and/or
A TAG ID;
The WD 22 transmits PRACH according to the PDCCH order. In some embodiments, the WD 22 repeats the PRACH transmission according to state-of-the-art methods, i.e., until it receives a random access response. In some embodiments, the WD 22 only transmits PRACH once, and does not expect to receive a random access response. In some embodiments, whether the WD 22 should expect to receive a RACH response may be indicated in the PDCCH order;
In some embodiments, for the case when the WD 22 receives the random access response, the WD 22 applies the included TA to one of the TAGs. The TAG may be determined implicitly based on the CORESET in which the PDCCH order is received or signaled in the PDCCH order or in the RACH response;
In some embodiments, for the case when the WD 22 receives the random access response, the WD 22 does not apply the TA;
In some embodiments, the NW estimates the TA based on the reception of the PRACH, and sends the TA associated with a TAG to the WD 22 using MAC CE. At the reception of the MAC CE, the WD 22 updates the TA associated with the TAG; and/or

In some embodiments, the TA is sent to the WD 22 in the absolute timing advance MAC CE, which has been extended with a TAG ID. See FIG. 21.

Re-Acquiring TA when One of the Two Timing Alignment Timers Expires

In some embodiments, when one of the two time-alignment timers expires, only UL transmissions to the associated TRP 16 are stopped. The WD 22 may then try to re-acquire TA associated to the TRP 16 by indicating to the network node 16 about expiration via the other TRP 16 for which the associated time alignment timer is still running. Assume the expired timer is associated to a second TRP 16 while the timer associated to a first TRP 16 is still running. Then the indication would be sent to the first TRP 16. The indication may be via one of the following examples:
A PUCCH resource for a scheduling request (SR) configured specifically for the purpose;
A MAC CE containing information about the expiration of the time alignment timer; and/or
A RRC message containing information about the expiration of the time alignment timer.

The first TRP 16 may forward the information to the second TRP 16 for which the timer has been expired. The second TRP 16 may then initiate a CFRA RACH procedure by sending a PDCCH order to the WD 22 to re-acquire TA associated to the second TRP 16. One or more of the following may be performed:
The WD sends a PRACH preamble to the second TRP 16 according to the PDCCH order;
The second TRP 16 sends a corresponding RAR with a TAC after detecting the PRACH preamble;
The WD applies the TAC to the TAG associated to the second TRP 16 after receiving the RAR; and/or
The WD re-starts the time alignment timer associated to the second TRP 16 and re-start UL transmission to the second TRP 16.

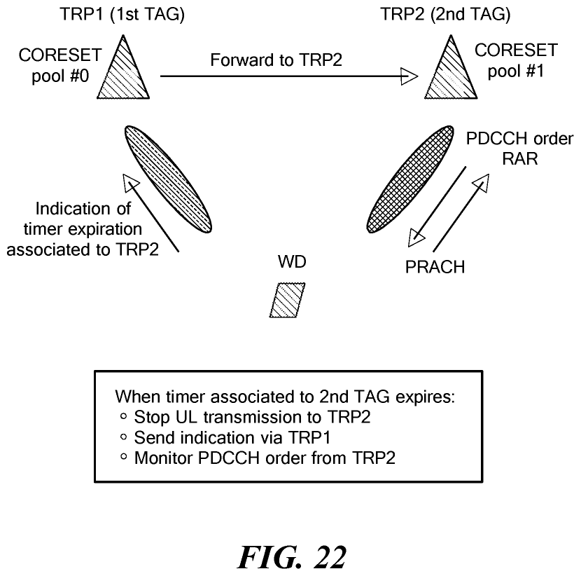

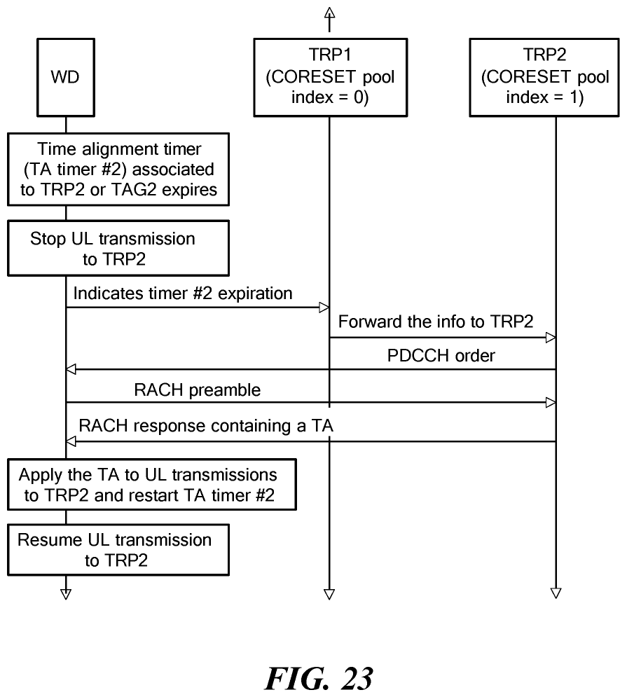

This is illustrated in the examples of FIGS. 22 and 23.

In some embodiments, the first TRP 16 may initiate a RACH procedure directly by requesting the WD 22 to send a PRACH preamble to the second TRP 16 for which the timer has expired.

In some embodiments, dedicated PRACH preamble(s) and resources may be configured for the purpose or re-acquiring TA when two TAGs are configured in a serving cell. A WD 22 may send a dedicated PRACH preamble to a TRP 16 when the associated time alignment timer expires. When a dedicated PRACH preamble is transmitted by the WD 22 to a TRP 16 associated with a TAG, the WD 22 may not expect to receive a RACH response and thus, may not monitor DCI 1-0 with CRC scrambled by RA-RNTI in a type1 CSS set. Instead, the WD 22 may monitor DCI with CRC scrambled by the WD's C-RNTI within a time window after the transmission of a dedicated PRACH preamble. The monitoring may be done in a dedicated search space set or in regular CORESETs associated to the TRP 16.

After the WD 22 detects a DCI format with CRC scrambled by C-RNTI in the search space set or in the CORESETs, the WD 22 may continue to monitor PDCCH candidates in the search space set or the CORESETs until the WD 22 receives a PDSCH carrying a MAC CE containing a timing advance command associated to the TAG. In this case, the timing advance command MAC CE may be sent to the WD 22 from the same TRP 16 to which the dedicated PRACH preamble is sent. The WD 22 then applies the TA in the TAC to the associated TAG and re-start UL transmissions to the TRP 16.

WD Procedure for the Case with Two PTAGs

In case the serving cell with two TRPs 16 and two TAGs is a SpCell, both of the two TAGs are PTAGs. In this case, there will be two PTAGs. When one of the time alignment timers expires while the other time alignment time is still running, only UL transmissions to the TRP 16 associated with the expired timer may be stopped. UL transmissions to the other TRP 16 may continue. Therefore, in one embodiment, the existing WD 22 procedure defined in clause 5.2 of 3GPP TS 38.321 may be modified as follows:
1> when a timeAlignmentTimer expires:
   2> if the timeAlignmentTimer is associated with a first PTAG and a time alignment timer associated with a second PTAG is still running:
      3> flush all HARQ buffers for all Serving Cells associated with the first PTAG;
      3> clear any configured downlink assignments and configured uplink grants associated with the first PTAG;
      3> clear any PUSCH resource for semi-persistent CSI reporting associated with the first PTAG;
      3> maintain N_{TA} (defined in 3GPP TS 38.211) of all TAGs;
   2> else if the timeAlignmentTimer is associated with an STAG and all the Serving Cells associated with this STAG are not associated with a second TAG, then for all Serving Cells belonging to this TAG:
      3> flush all HARQ buffers;
      3> notify RRC to release PUCCH, if configured;
      3> notify RRC to release SRS, if configured;
      3> clear any configured downlink assignments and configured uplink grants;
      3> clear any PUSCH resource for semi-persistent CSI reporting;
      3> maintain N_{TA} (defined in 3GPP TS 38.211) of this TAG.
   2> Otherwise if the time Alignment Timer is associated with an STAG and at least one of the Serving Cells associated with this TAG is associated with a second TAG, then for the at least one of Serving Cells belonging to this TAG and also associated with a second TAG:
      3> flush all HARQ buffers associated with the STAG:
      3> flush all HARQ buffers associated with the STAG:
      3> clear any configured downlink assignments and configured uplink grants associated with the STAG:
      3> clear any PUSCH resource for semi-persistent CSI reporting associated with the STAG:
      3> maintain N_{TA} of the second TAG.

In case of a SpCell, the first PTAG is the TAG whose time Alignment Timer has expired. In some embodiments, when the timer associated to the second PTAG is still running, RRC is not notified to release PUCCH or SRS, since the WD 22 may still transmit PUCCH or SRS using N_{TA} associated with the second PTAG. Also, configured downlink assignments and configured uplink grants associated with the second PTAG (i.e., the PTAG whose time Alignment Timer is still running) are not cleared as the WD 22 may still transmit PUSCH using N_{TA} associated with the second PTAG. Similarly, PUSCH resource for semi-persistent CSI reporting associated with the second PTAG is not cleared as the WD 22 may still transmit semi-persistent CSI reporting on PUSCH using N_{TA} associated with the second PTAG.

In some embodiments, in case of a SCell and when the timer associated to the first TAG expires, RRC is not notified to release PUCCH or SRS, since the WD 22 may still transmit PUCCH or SRS using N_{TA} associated with the second TAG (i.e., the TAG whose time Alignment Timer is still running). Also, configured downlink assignments and configured uplink grants associated with the second TAG are not cleared as the WD 22 may still transmit PUSCH using N_{TA} associated with the second TAG. Similarly, PUSCH resource for semi-persistent CSI reporting associated with the second TAG is not cleared as the WD 22 may still transmit semi-persistent CSI reporting on PUSCH using N_{TA} associated with the second TAG.

In some embodiments, when the TA is invalid for both the TAGs (e.g., timeAlignmentTimer is expired for all the TAGs), when WD 22 may transmit PRACH to only one TRP 16 at a time, the WD 22 may prioritize the transmission of the PRACH to the TRP 16 whose SSB power (signal strength or RSRP) is higher.

In some embodiments, when the TA is invalid for both the TAGs (e.g., timeAlignmentTimer is expired for all the TAGs), when the WD 22 may transmit PRACH to only one TRP 16 at a time, the network node 16 indicates the prioritization information to the WD 22 (e.g., through a RRC message). The WD 22 may prioritize the transmission of the PRACH to the TRP 16 whose TRP is indicated by the network node 16.

In some embodiments, when the TA is invalid for both the TAGs (e.g., timeAlignmentTimer is expired for all the TAGs), when the WD 22 may transmit PRACH to only one TRP 16 at a time, the WD 22 may prioritize the transmission of the PRACH to the TRP 16 based on WD 22 implementation preference.

Some embodiments may include one or more of the following:

Example A1. A network node configured to communicate with a wireless device (WD), the network node configured to, and/or comprising a radio interface and/or comprising processing circuitry configured to:
transmit to the WD a physical downlink control channel, PDCCH, order;
receive from the WD physical random access channel, PRACH, in response to the PDCCH order; and
transmit to the WD a timing advance command, TAC, in one of a medium access control, MAC, control element, CE, and a random access response, RAR.

Example A2. The network node of Embodiment A1, wherein the TAC is associated with one of two timing advance groups, TAG.

Example A3. The network node of Embodiment A2, wherein each TAG is associated with an alignment timer.

Example B1. A method implemented in a network node, the method comprising:
transmitting to the WD a physical downlink control channel, PDCCH, order;
receiving from the WD physical random access channel, PRACH, in response to the PDCCH order; and
transmitting to the WD a timing advance command, TAC, in one of a medium access control, MAC, control element, CE, and a random access response, RAR.

Example B2. The method of Embodiment B1, wherein the TAC is associated with one of two timing advance groups, TAG.

Example B3. The method of Embodiment B2, wherein each TAG is associated with an alignment timer.

Example C1. A wireless device (WD) configured to communicate with a network node, the WD configured to, and/or comprising a radio interface and/or processing circuitry configured to:
receive from the network node a physical downlink control channel, PDCCH, order;
transmit to the network node a physical random access channel, PRACH, according to the PDCCH order; and
monitor for, and receive, from the network node a timing advance command, TAC, and an associated timing advance group, TAG, ID on one of a medium access control, MAC, control element, CE, and a random access response, RAR.

Example C2. The WD of Embodiment C1, wherein the WD, radio interface and/or processing circuitry are further configured to apply a timing advance, TA, indicated by the TAC.

Example C3. The WD of any of Embodiments C1 and C2, wherein the WD, radio interface and/or processing circuitry are further configured to reacquire a timing advance, TA, when of two alignment timers associated with two timing advance groups, TAGs, expires.

Example C4. The WD of Embodiment C3, wherein the WD, radio interface and/or processing circuitry are further configured to notify the network node of the expiration of the one of two alignment timers.

Example C5. The WD of any of Embodiments C3 and C4, wherein the WD, radio interface and/or processing circuitry are further configured to initiate a PRACH with dedicated preamble and monitor for another TAC.

Example D1. A method implemented in a wireless device (WD), the method comprising:
receiving from the network node a physical downlink control channel, PDCCH, order;
transmitting to the network node a physical random access channel, PRACH, according to the PDCCH order; and
monitoring for, and receiving, from the network node a timing advance command, TAC, and an associated timing advance group, TAG, ID on one of a medium access control, MAC, control element, CE, and a random access response, RAR.

Example D2. The method of Embodiment D1, further comprising applying a timing advance, TA, indicated by the TAC.

Example D3. The method of any of Embodiments D1 and D2, further comprising reacquiring a timing advance, TA, when of two alignment timers associated with two timing advance groups, TAGs, expires.

Example D4. The method of Embodiment D3, further comprising notifying the network node of the expiration of the one of two alignment timers.

Example D5. The method of any of Embodiments D3 and D4, further comprising initiating a PRACH with dedicated preamble and monitor for another TAC.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-15. (canceled)

16. A method in a network node configured to communicate with a wireless device, WD, the method comprising:
configuring the WD to stop first uplink transmissions associated with a first time alignment timer for a first timing advance group, TAG, in a first serving cell when the first time alignment timer expires; and
configuring the WD to continue second uplink transmissions associated with a second time alignment timer for a second TAG in the first serving cell after the first time alignment timer has expired but before the second time alignment timer expires.

17.-30. (canceled)

31. A wireless device, WD, configured to communicate with a network node, the WD configured to:
stop first uplink transmissions associated with a first time alignment timer for a first timing advance group, TAG, in a serving cell when the first time alignment timer expires; and
continue second uplink transmissions associated with a second time alignment timer for a second TAG in the same serving cell after the first time alignment timer has expired but before the second time alignment timer expires.

32. (canceled)

33. The WD of claim 31, wherein the first and the second uplink transmissions include transmissions of one or more of a physical uplink shared channel, PUSCH, physical uplink control channel, PUCCH, and sounding reference signal, SRS.

34. (canceled)

35. The WD of claim 31, wherein the WD is configured to:
flush hybrid automatic repeat request, HARQ, buffers associated with the first primary TAG;
clear any configured downlink assignments and configured uplink grants associated with the first TAG;
clear any PUSCH resource for semi-persistent channel state information, CSI, reporting associated with the first TAG; and
maintain timing advance values of both the first and second TAGs.

36. The WD of claim 31, wherein the WD is configured to, when at least one serving cell belonging to the first TAG is also associated with a third TAG, for which an associated time alignment timer has not expired, configured the WD to:
flush hybrid automatic repeat request buffers associated to the first TAG for the at least one serving cell;
clear any configured downlink assignments and configured uplink grants; associated with the first TAG;
clear any PUSCH resource for semi-persistent channel state information, CSI; reporting associated with the first TAG; and
maintain timing advance values of both the first and second TAGs.

37. (canceled)

38. The WD of claim 31, wherein continuing the second uplink transmissions includes transmitting at least one of an uplink control channel and a reference signal using a timing advance associated with the second primary TAG.

39. The WD of claim 31, wherein the WD is configured to retain configured downlink assignments and configured uplink grants associated with the second primary TAG when the first time alignment timer has expired and the second time alignment timer has not expired.

40. (canceled)

41. The WD of claim 31, wherein the WD is configured to, when the first and second time alignment timer have expired, prioritize transmission of a physical random access channel to one of the first and second TRPs, the prioritization being based at least in part on a comparison of signal powers of the first and second TRPs.

42. (canceled)

43. A method in a wireless device, WD, configured to communicate with a network node, the method comprising:
stopping first uplink transmissions associated with a first time alignment timer for a first timing advance group, TAG, in a serving cell when the first time alignment timer expires; and
continuing second uplink transmissions associated with a second time alignment timer for a second TAG in the same serving cell after the first time alignment timer has expired but before the second time alignment timer expires.

44. The method of claim 43, wherein the first and the second TAGs are both primary TAGs, a primary TAG including a primary cell or a special cell.

45. The method of claim 43, wherein the first and the second uplink transmissions include transmissions of one or more of a physical uplink shared channel, PUSCH, physical uplink control channel, PUCCH, and sounding reference signal, SRS.

46. The method of claim 43, wherein the first and the second uplink transmissions are associated to the first and the second TAGs, respectively.

47. The method of claim 43, further comprising:
flushing hybrid automatic repeat request, HARQ, buffers associated with the first primary TAG;
clearing any configured downlink assignments and configured uplink grants associated with the first TAG;
clearing any PUSCH resource for semi-persistent channel state information, CSI, reporting associated with the first TAG; and
maintaining timing advance values of both the first and second TAGs.

48. The method of claim 43, further comprising, when at least one serving cell belonging to the first TAG is also associated with a third TAG, for which an associated time alignment timer has not expired:
flushing hybrid automatic repeat request buffers associated to the first TAG for the at least one serving cell;
clearing any configured downlink assignments and configured uplink grants; associated with the first TAG;
clearing any PUSCH resource for semi-persistent channel state information, CSI reporting associated with the first TAG; and
maintaining timing advance values of both the first and second TAGs.

49. The method of claim 47, wherein the third TAG is one of a primary TAG and a secondary TAG.

50. The method of claim 43, wherein continuing the second uplink transmissions includes transmitting at least one of an uplink control channel and a reference signal using a timing advance associated with the second primary TAG.

51. The method of claim 43, further comprising retaining configured downlink assignments and configured uplink grants associated with the second primary TAG when the first time alignment timer has expired and the second time alignment timer has not expired.

52. (canceled)

53. The method of claim 43, further comprising, when the first and second time alignment timer have expired, prioritizing transmission of a physical random access channel to one of the first and second TRPs, the prioritization is based at least in part on a comparison of signal powers of the first and second TRPs.

54. (canceled)

55. The wireless device of claim 31, wherein the wireless device is further configured to:
transmit, to the network node, a dedicated physical random access channel, PRACH, preamble, the dedicated PRACH preamble being associated with one of the first TAG and the second TAG; and
receive, from the network node in a downlink control information, DCI, a cyclic redundancy code, CRC, scrambled by a cell radio network temporary identifier, C-RNTI, of the WD within a time window after transmission of the dedicated PRACH preamble by the WD.

56. The method of claim 43, further comprising:
transmitting a dedicated physical random access channel, PRACH, preamble, the dedicated PRACH preamble being associated with one of the first TAG and the second TAG; and
receiving in a downlink control information, DCI, a cyclic redundancy code, CRC, scrambled by a cell radio network temporary identifier, C-RNTI, of the WD within a time window after transmission of the dedicated PRACH preamble by the WD.
